(19) United States
(12) Patent Application Publication
(10) Pub. No.: US 2012/0282368 A1
(43) Pub. Date: Nov. 8, 2012

(54) AMPHIPHILIC STEROL/FAT-BASED PARTICLES

(75) Inventors: Daniel Perlman, Arlington, MA (US); Kenneth C. Hayes, Wellesley, MA (US); Andrzej Pronczuk, Milton, MA (US); Fadi Chaabo, Weston, MA (US)

(73) Assignee: Brandeis University, Waltham, MA (US)

(21) Appl. No.: 13/100,236

(22) Filed: May 3, 2011

(51) Int. Cl. A23D 7/005; A23D 9/007; A23C 9/152; A23C 11/10; A23C 13/00; A23C 9/123; A23L 1/24; A23L 1/40; A23L 2/38; A23L 1/035; A23C 19/076

(52) U.S. Cl. 426/2; 426/601; 426/613; 426/590; 426/580; 426/598; 426/582; 426/583; 426/605; 426/589; 426/607

(57) ABSTRACT

The present invention relates to amphiphilic sterol- and fat-based particles, which can be dispersed in liquid foods and beverages such as milk. The compositions provided, when consumed, reduce low-density lipoprotein (LDL) and total plasma cholesterol (TC) levels.

### BACKGROUND

Triglyceride-recrystallized non-esterified phytosterol (TRP) complexes are formed by heat-dissolving non-esterified phytosterols in edible fat (e.g., edible oil), and subsequently cooling the resultant combination to permit crystallization of the phytosterol/triglyceride mixture and formation of the TRP complex. Applicants previously found that when ingested, TRP complexes reduced mammalian plasma cholesterol and peroxide levels (U.S. Pat. Nos. 7,709,038, 7,575,768, 7,144,595 and 6,638,547, incorporated herein by reference).

The TRP complexes do not disperse in water, and instead form a sticky and cohesive paste.

### SUMMARY OF THE INVENTION

Provided herein are amphiphilic sterol- and fat-based particles (“amphiphilic particles”) that, when added to water-containing liquids (referred to herein as “liquids”) (e.g., beverages and liquid foods), surprisingly disperse therein. When regularly ingested, these amphiphilic particles reduce LDL and total plasma cholesterol (TC) levels (and the ratio of LDL to HDL cholesterol). Also provided herein are beverages and liquid foods comprising the amphiphilic sterol- and fat-based particles.

In certain aspects, provided herein are compositions, comprising: (a) at least one non-esterified phytosterol co-crystallized with at least one triglyceride-based edible fat; and (b) at least one amphiphilic agent in an amount effective to form an amphiphilic particle that disperses in beverages and liquid foods. In some embodiments, component (a) comprises: at least one non-esterified phytosterol in an amount of about 2% to about 75% by weight; and at least one triglyceride-based edible oil or fat in an amount of about 25% to about 98% by weight. In some embodiments, the amphiphilic particles are micro-particles. As used herein, the term, “at least one,” is used interchangeably with a, one, and one or more. By way of example, the compositions provided herein are compositions comprising: (a) at least one (a, one, one or more) non-esterified phytosterol co-crystallized with at least one (a, one, one or more) triglyceride-based edible fat; and (b) at least one (a, one, one or more) amphiphilic agent in an amount effective to form an amphiphilic particle that disperses in beverages and liquid foods. In some embodiments, component (a) comprises: at least one (a, one, one or more) non-esterified phytosterol in an amount of about 2% to about 75% by weight; and at least one (a, one, one or more) triglyceride-based edible oil or fat in an amount of about 25% to about 98% by weight.

In some embodiments, the at least one triglyceride-based edible fat is vegetable oil, vegetable fat, animal oil, animal fat, or a mixture thereof.

In other embodiments, the at least one non-esterified phytosterol is a plant oil- or vegetable oil-derived phytosterol or phytostanol, a tall oil-derived phytosterol or phytostanol, or a combination thereof.

In certain embodiments, the at least one amphiphilic agent comprises at least one emulsifier. In some embodiments, the at least one emulsifier is a non-protein-based emulsifier, while in other embodiments, the at least one emulsifier is a water-soluble protein or a protein-based powder. In some embodiments, the at least one emulsifier is a modified lecithin, such as hydrolyzed lecithin or hydroxylated lecithin. Lecithins used in the compositions described herein are modified such that they are more hydrophilic relative to the corresponding unmodified lecithins. In other embodiments, the at least one emulsifier is a monoglyceride and/or a diglyceride. In certain embodiments, the water-soluble protein is a milk protein or soy protein. The milk protein may be casein, beta-lactoglobulin, or alpha-lactalbumin. In other embodiments, the emulsifier comprises a mixture of proteins (e.g., a mixture of different milk proteins).

In certain embodiments, the amphiphilic agent comprises at least one non-protein-based emulsifier and at least one water-soluble protein.

In some embodiments, the amphiphilic particles form a paste, while in other embodiments, the amphiphilic particles form a powder. In yet other embodiments, an oily and variably fluid suspension of amphiphilic particles is obtained when the weight ratio of vegetable oil co-crystallized with free sterol is, for example, 10:1, 20:1, or greater. In some embodiments, when the weight ratio is 5:1 or less, a thick paste is typically formed instead.

In certain embodiments, the compositions provided herein can be added to or combined with a beverage, a liquid food, a liquid dietary supplement, or a liquid food additive. The beverage may be cow's milk, sheep's milk, goat's milk, soymilk, almond milk, or coconut milk. Liquid foods include yogurt, cottage cheese, sour cream, soup, salad dressing, tomato catsup, mustard, barbecue sauce, steak sauce, Worcestershire sauce, cocktail sauce, tartar sauce, pickle relish, tomato-based pasta sauce, pizza sauce, prepared chili, or dessert sauce.

Also provided herein are beverages or liquid foods that comprise any one of the foregoing compositions.

Other aspects provided herein include methods for reducing plasma cholesterol levels in an individual, comprising administering to the individual any one of the compositions described herein in an amount sufficient and over a period sufficient to reduce plasma cholesterol levels in the individual.

Further aspects include methods of producing any one of the foregoing compositions, comprising: (a) obtaining a complex comprising at least one non-esterified phytosterol co-crystallized with at least one triglyceride-based edible fat; and (b) combining with the complex of (a) at least one amphiphilic agent in an amount and under conditions sufficient to form an amphiphilic particle that disperses in liquid.

Yet other aspects include methods of producing any one of the foregoing compositions, comprising: (a) combining between about 2% and 75% by weight of non-esterified phytosterols with between about 25% and 98% of at least one triglyceride-based edible fat; (b) heating and mixing the non-esterified phytosterols and fat in (a) so that (under conditions under which) the non-esterified phytosterols dissolve or become dissolved in the edible fat, thereby producing non-esterified phytosterols dissolved in edible fat; (c) cooling the non-esterified phytosterols dissolved in fat in (b) so that (under conditions under which) the non-esterified phytosterols and fat co-crystallize to form a complex; and (d) combining the complex formed in (c) with at least one amphiphilic agent in an amount effective to form an amphiphilic particle that disperses in liquid. Also provided herein are compositions produced by any one of the foregoing methods or embodiments.

### DETAILED DESCRIPTION OF SOME EMBODIMENTS OF THE INVENTION

Non-esterified phytosterols (free sterols and/or stanols) that are co-crystallized with at least one triglyceride/fat (e.g., oil) to form a hydrophobic complex are referred to as triglyceride-recrystallized phytosterol (TRP) complexes. TRP complexes are particularly useful as additives to solid, high-fat foods. Consumption of food products containing TRP complexes reduces plasma levels of LDL and total cholesterol (TC). Addition of TRP complexes to food also limits oxidation of associated triglycerides (reduces or controls oxidative rancidity in fats, including the stabilization of heated fats and oils against premature oxidation). Regular dietary intake of TRP complexes (intake of approximately 1-2 g of phytosterols per day) typically results in a substantial reduction in plasma LDL and TC (see U.S. Pat. Nos. 7,709,038, 7,575,768, 7,144,595 and 6,638,547, each of which is herein incorporated by reference in its entirety). However, these TRP complexes are water-insoluble and cannot be used in beverages and other liquid compositions, for example cow's milk or soymilk. Described herein are amphiphilic sterol- and fat-based particles, which can be dispersed in liquid (water-containing liquid) (e.g., beverage, drinkable food product or fluid food product) and when consumed can be used as a cholesterol-lowering agent, such as a cholesterol-lowering supplement for beverages (e.g., milk).

The compositions provided herein comprise sterol- and fat-based complexes (TRP complexes) and at least one edible amphiphilic agent. The term “amphiphilic agent” (or “amphipathic agent”) refers to an agent that has both water-loving (hydrophilic) and fat-loving (lipophilic) properties. The term “edible” means that the composition is suitable for use in mammalian (e.g., human, livestock) foods, dietary supplements and pharmaceutical preparations. The preformed TRP complexes may be produced by any one of the methods disclosed in U.S. Pat. Nos. 7,709,038, 7,575,768, 7,144,595 and 6,638,547. For example, the TRP complex can be produced by heat-dissolving and mixing sterols in fat, cooling the dissolved sterol/fat mixture, and allowing the sterol/fat mixture to crystallize. In certain embodiments, the TRP complex contains non-esterified phytosterols and/or phytostanols (also referred to herein as phytosterols, plant sterols, or sterols) combined in a hydrophobic crystalline complex or matrix with triglyceride-based fats (e.g., oils). The term “fat” may be used broadly and generally, referring to an edible triglyceride that may be either liquid (also specifically termed oil) or solid at room temperature (also specifically termed fat), and that is derived from a vegetable source (e.g., soybean, cottonseed, corn) or an animal source (e.g., beef tallow, pork lard) or a blended combination of sources. As used herein, the term “fat” includes oils, for example, safflower oil, sunflower oil, corn oil, cottonseed oil, soybean oil, canola oil, peanut oil, coconut oil, cocoa butter, palm oil, palm olein, palm super-olein, palm kernel oil, algae oil, flaxseed oil, and combinations thereof. The term “fat” includes chemically and enzymatically modified triglyceride-based liquid and solid fats and blends thereof (e.g., hydrogenated, partially hydrogenated, chemically or enzymatically interesterified, or assembled (e.g., “structured” triglycerides) and combinations thereof. In some embodiments, the weight ratio of the two components in the fat-based composition is between about 2% sterols/about 98% fat and about 75% sterols/about 25% fat.

In certain embodiments, the sterol/fat-based complexes are formed by heating and mixing the non-esterified phytosterols in fat (e.g., triglycerides) to a temperature of greater than 60° C. for a period of time sufficient to dissolve the non-esterified phytosterols in the fat, and subsequently cooling this composition to a temperature, such as room temperature, to allow the components to crystallize and form complexes. In some embodiments, the sterol- and fat-based complexes are formed after the combined sterols and fat are heated to a temperature of between 75° C. and 120° C., or higher. In one embodiment, the complexes are formed after the sterol- and fat-based composition are heated to a temperature of about 110° C. In another embodiment, the combined sterols and fat are heated to a temperature of greater than 120° C. In yet another embodiment, the combined sterols and fat are heated to a temperature of greater than 190° C.

In some embodiments, the non-esterified phytosterols are selected from the group consisting of tall oil-derived phytosterols (such as those obtained from the manufacture of wood pulp from pine trees) and vegetable oil-derived phytosterols (such as those derived from soybean oil). In particular embodiments, the preformed (combined) sterol/fat-based complex comprises non-esterified phytosterols at a level of greater than 25% (of the combined weight of complex) to less than or equal to 30%, 30-35%, 35-40%, 40-45%, 45-50%, 50-55%, 55-60%, 60-65%, 65-70%, or 70-75% by weight. In other embodiments, the preformed sterol/fat-based complex contains at least 3%, 5%, 7%, 10%, 12%, 15%, 17%, 20%, 23% or 25% by weight of non-esterified phytosterols in the complex.

In certain aspects, provided are compositions comprising the sterol/fat-based complexes (e.g., TRP complexes) combined (mixed or blended) with at least one amphiphilic agent to produce amphiphilic sterol- and fat-based particles, referred to herein as “amphiphilic particles.” In other aspects, provided herein are methods of producing amphiphilic particles comprising combining with preformed sterol/fat-based complexes (e.g., with preformed TRP complexes) at least one amphiphilic agent (or a mixture of agents) in an amount sufficient to bind to and presumably mask most of the hydrophobic fat (triglyceride) and sterol components in the preformed complex, thereby formulating amphiphilic sterol/fat-based particles that are dispersible in liquid substances. The amphiphilic particles that are dispersed in liquid are bioactive and, when ingested, components of the particles (TRP complexes) reduce human plasma LDL cholesterol levels and the ratio of LDL to HDL cholesterol with high efficacy. In certain embodiments, there is at least a 10% decrease in plasma LDL cholesterol following regular daily intake of 2 g phytosterols in the form of amphiphilic particles described herein, such as regular daily intake in roughly equal portions consumed two or three times a day, such as in two or three meals per day for a period of approximately 2 weeks or longer, depending on the individual and the individual's cholesterol metabolism. Increasing the daily intake of phytosterols from approximately 2 g to a level of 4 g per day is expected to further decrease an individual's plasma LDL cholesterol level.

The amphiphilic particles dispersed in, for example, low-fat beverages, such as low-fat cow's milk or soymilk, and consumed on a regular basis, as described herein, are effective in reducing plasma levels of total cholesterol (TC) and LDL cholesterol. This is particularly advantageous and unexpected, as it is generally accepted that substantial amounts of fat are required for sterol efficacy in lowering LDL and total cholesterol levels. Without being bound by theory, it is believed likely that fat carried within the preformed sterol/fat-based complexes remains bound within the amphiphilic particles, even after combining the preformed complexes with the amphiphilic agent(s) (e.g., non-protein emulsifiers, protein powders).

In certain embodiments, the amphiphilic particles comprise:

(a) a complex comprising from about 2% to about 75% by weight of non-esterified phytosterols co-crystallized with from about 25% to about 98% of at least one triglyceride-based edible fat (e.g., edible oil); and

(b) at least one edible amphiphilic agent in an amount sufficient to achieve dispersal of the amphiphilic particles in beverage (e.g., cow's milk and/or soymilk) or liquid food (e.g., yogurt, soup).

Co-crystallization of the complex in (a) is achieved by combining, heating, mixing and dissolving together the non-esterified phytosterols and triglyceride-based edible fat or oil, and then cooling the mixture to allow co-crystallization to occur.

Combining an amphiphilic agent with the preformed sterol- and fat-based complexes provides amphiphilic particles that disperse in liquids, and therefore, can be included in edible liquid products. Use of amphiphilic particles results in a greater bioavailability of the sterol/fat-based complexes than is the case for sterol/fat-based complexes that are not formulated as amphiphilic particles (e.g., TRP complexes). Consumption of amphiphilic particles, such as consumption in a beverage or a liquid food, results in reduction in human levels of plasma LDL cholesterol and the ratio of LDL to HDL cholesterol. In certain embodiments, there is at least about 10% reduction in plasma LDL cholesterol levels following regular daily intake of 2 g phytosterols (preferable consumed in two or three doses during the day).

In certain embodiments, the edible amphiphilic agents described herein impart nutrition to the liquid substance (e.g., food or beverage) while simultaneously promoting dispersal of the amphiphilic particles. The production and use of the presently described amphiphilic particles facilitate the incorporation of natural plant sterols into liquid substances while employing ingredients from essentially natural (e.g., modified by hydroxylation or hydrolysis).

In some embodiments, an edible amphiphilic agent is an emulsifier. In some embodiments, the amphiphilic emulsifier is a non-protein emulsifier, while in other embodiments, the amphiphilic emulsifier is a protein-based powder. Non-protein emulsifiers include modified (e.g., hydrolyzed or hydroxylated) lipids such as monoglycerides and/or diglycerides or phospholipids (e.g., hydrolyzed or hydroxylated lecithin). Protein-based powders include non-fat milk powder, powdered casein, whey protein concentrate, and soy protein concentrate powder.

A range of concentrations of non-protein emulsifier (e.g., modified lecithin, monoglycerides and/or diglycerides) can be used to produce amphiphilic particles, such as from about 2% to about 20% by weight of the composition, from about 7% to about 20% by weight of the composition, from about 10% to about 20% by weight of the composition, from about 5% to about 20% by weight of the composition, or from about 2% to about 25% by weight of the composition. In certain embodiments, only a small amount of a non-protein emulsifier is used to form the amphiphilic particles. In some embodiments between about 2% and about 15% by weight of emulsifier (based on the total weight of the amphiphilic particles including sterol, fat and emulsifier) is combined with preformed sterol- and fat-based complexes to form amphiphilic particles. In such small proportional quantities, the emulsifier does not change the physical state of amphiphilic particles from a fluid or semi-solid to a powder.

A wide range of concentrations of protein emulsifier (e.g., water-soluble protein) can be used to produce amphiphilic particles, such as from about 2% to about 70% by weight of the composition, from about 7% to about 70% by weight of the composition, from about 10% to about 70% by weight of the composition, from about 5% to about 70% by weight of the composition, or from about 2% to about 25% by weight of the composition. In some embodiments, between about 7% and about 45% by weight of emulsifier (based on the total weight of the amphiphilic particles including sterol, fat and emulsifier) is combined with preformed sterol- and fat-based complexes to form amphiphilic particles.

In other embodiments, a protein is added in an amount equal to or greater than the weight of the sterol/fat (TRP) component. In some embodiments, the protein serves to convert the particles into amphiphilic powders.

Modified (e.g., hydrolyzed or hydroxylated) lecithin and protein-based powder (protein-rich powder, e.g., milk powder, soy protein powder), are both amphiphilic, but are typically included in compositions described herein in different amounts/% of a composition. Formulation of amphiphilic particles using modified lecithins require concentrations typically 10-fold less that those required for formulation of amphiphilic particles using protein-based powders. For example, 1-4 g of milk or soy protein powder (e.g., 1-4 g of milk protein powder) are required to formulate water-dispersible amphiphilic particles (containing 1 g fat and 1 g sterols), while as little as 0.1-0.2 g of a hydrolyzed lecithin can be used to formulate water-dispersible amphiphilic particles containing similar amounts of fat and sterols.

Depending on the application, it may be advantageous to use combinations of non-protein and protein-based emulsifiers to formulate the amphiphilic particles. In such embodiments, a water-dispersible amphiphilic sterol/fat-based powder is formed. The amount and proportion of each ingredient can be determined empirically. These amounts and proportions may vary widely. For example, while a non-protein emulsifier such as modified lecithin may be present at a level of 5% of the amphiphilic particle weight, a protein-rich powder such as non-fat milk solids may be present at a level of 50% of the particle weight.

In certain embodiments, the amphiphilic particles described herein can comprise an emulsifier at a level of about 2% to about 70% of the amphiphilic particle weight.

In some embodiments, non-protein emulsifier is present at a level of about 1% to about 10% of the amphiphilic particle weight. In other embodiments, it is present at a level of about 5% of the amphiphilic particle weight.

In particular embodiments, a protein-based emulsifier is present at a level of about 50% to about 70% of the amphiphilic particle weight. In other embodiments, it is present at a level of about 66% (or ⅔) of the amphiphilic particle weight.

Amphiphilic Particles Formulated with Non-Protein Emulsifiers

In some embodiments, the amphiphilic particles are formulated and combined (e.g., admixed) with at least one non-protein emulsifier. Amphiphilic non-protein emulsifiers can be, for example, modified (e.g., hydrolyzed or hydroxylated) lecithins. Lecithins typically include phosphoric acid, choline, fatty acids, glycerol, glycolipids, triglycerides and phospholipids (e.g., phosphatidylcholine, phosphatidylethanolamine and phosphatidylinositol). Lecithin may be solvent-extracted from soybeans, sunflower seeds, rapeseeds, egg yolk, blood, bile, brain tissue and fish eggs. Lecithin (unmodified) has low solubility in water but is typically classified as an amphiphilic surfactant. Despite the fact that it seems to be amphiphilic, surprisingly, unmodified lecithin was not effective (not sufficiently effective) in producing amphiphilic sterol- and fat-based particles. That is, when unmodified lecithin was combined with the preformed TRP complexes, it was not possible to achieve full (homogenous and stable) dispersal of the TRP complexes. In particular embodiments, however, unmodified lecithin can be combined with modified lecithin or other emulsifier(s) to form amphiphilic particles. Lecithins used in the compositions described herein are modified such that they are more hydrophilic relative to unmodified lecithins. In some embodiments, natural vegetable lecithins are modified by either hydroxylation or hydrolysis (e.g., modified sunflower lecithin), rendering the lecithins sufficiently hydrophilic so that when combined with the preformed sterol/fat-based complexes, the resultant amphiphilic particles are dispersible in water/liquids (e.g., cow's milk or soymilk).

When considering emulsifiers, it may be important to consider the hydrophilic-lipophilic balance (HLB) of a candidate molecule. The HLB may be calculated based on values for the different regions of the emulsifier molecule. W. C. Griffin's method for non-ionic emulsifiers dating from the 1950's considered the molecular mass of the hydrophilic portion of a molecule compared to the whole molecule, to provide an HLB number on an arbitrary scale of 0 to 20. A value of 0 corresponds to a fully lipophilic molecule while a value of 20 corresponds to a fully hydrophilic molecule. According to Griffin, the HLB value may predict the surfactant properties of a molecule. More specifically, a value from 4 to 6 indicates a water in oil (w/o) emulsifier while a value from 8 to 18 indicates an oil in water (o/w) emulsifier. In certain embodiments, herein, emulsifiers include those that emulsify an oily sterol complex into water. In some embodiments, the applicable HLB range is about 8 to about 18. In particular embodiments, lecithins used in the amphiphilic particles described herein can be modified such that they have a HLB range of about 8 to about 18. In other embodiments, an amphiphilic emulsifier or mixture of amphiphilic emulsifier molecules having both lipophilic and hydrophilic chemical properties can be used. In yet other embodiments, because the beverages to be supplemented with the amphiphilic particles include cow's milk and soymilk that are often purchased by health-conscious consumers, the emulsifier can be derived from a natural source. For example, lecithin that is prepared directly or indirectly from a natural food source material can be used. In certain embodiments, the emulsifier may include chemically synthesized emulsifiers, such as a sorbitan derivative or a polyethylene glycol.

In one embodiment, the amphiphilic particles include hydrolyzed sunflower lecithin (Giralec® HE-60 or Giralec® H-US produced by Austrade, Inc., Palm Beach Gardens, Fla.), soybean-derived sterols (FG-50 Corowise® brand, Cargill, Inc. (Minneapolis, Minn.)) and, high oleic sunflower oil (Clear Valley® brand, Cargill, Inc. (Minneapolis, Minn.)). In some embodiments, from about 90% to about 99% by weight of the preformed sterol/fat-based complex is blended with from about 10% to about 1% by weight of modified lecithin to produce amphiphilic particles dispersible in liquids (including beverages and fluid foods). In other embodiments, from about 94% to about 98% by weight of the preformed complex is blended with from about 6% to about 2% by weight of modified lecithin. In yet other embodiments, about 92.5% by weight of the preformed complex is blended with about 7.5% by weight of modified lecithin.

In certain embodiments, hydrolysis of lecithins is performed using enzymatic phospholipase A rather than acid or base hydrolysis, allowing the beta (sn-2) fatty acid to be selectively removed. In other embodiments, hydroxylation of lecithins is performed by reacting lecithin with hydrogen peroxide and lactic or acetic acid. In particular embodiments, hydroxyl groups are added at sites of unsaturation in the lecithin's fatty acids.

Modified lecithins used herein include: Yelkin®1018 soy lecithin (hydroxylated) with an HLB of 9, produced by ADM, Inc.; Alcolec® C LPC20 canola lecithin (enzyme-hydrolyzed) with an HLB of 12, produced by American Lecithin Company (ALC, Inc.), Oxford, Conn.; Alcolec® EM soy lecithin (enzyme-hydrolyzed) with an HLB of 9, produced by ALC; and Giralec®HE-60 sunflower lecithin (enzyme-hydrolyzed) with an HLB of 8-9, produced by Austrade, Inc., Palm Beach Gardens, Fla. In certain embodiments, modified lecithins are certified as produced from natural non-genetically modified organisms.

In spite of the fact that phytosterols differ greatly in their chemistry from triglycerides, Applicant has found that the amphiphilic particles appear to be uniformly and stably dispersed throughout a liquid medium using modified (e.g., hydrolyzed or hydroxylated) lecithins having HLB values of between about 8 to about 12 that are typical for emulsifiers of oil in water. Natural (unmodified) lecithins are not sufficiently active to achieve this uniform and stable dispersal. As used herein, stable dispersal of amphiphilic particles (or preformed TRP complexes) means that the particles do not separate (float or sink) from the liquid to which they are added, that is, to the extent that they can't be re-dispersed with shaking.

When the amphiphilic particles containing lecithin are heated to their melting points and cooled, the three constituents co-solidify and the resulting solids are not water-dispersible. While not being bound by theory, it is possible that when the three constituents of the amphiphilic particles (sterols, fat, and lecithin) are melted together, the chemical availability and surface activity of the lecithin for emulsifying the sterol/fat-based complexes is greatly diminished. That is, after melting, the lecithin, which is initially present on the surface of preformed complexes in the amphiphilic particles, may become diluted within the bulk of sterols and fat and, as a result, functionally masked from an external aqueous liquid. A similar phenomenon was observed when several different mono- and diglyceride emulsifiers were blended with the sterol/fat-based complexes. Re-melting of the preformed complexes together with an amphiphilic emulsifier results in a substantial loss of emulsifier activity. Thus, an important element in formulating the amphiphilic particles as described herein involves mixing/blending an amphiphilic emulsifier with the preformed sterol/fat-based complex without re-melting the preformed complex. The emulsifier thereby remains within or near the surface of the amphiphilic particles where the emulsifier can directly interact with both water and the sterols/fats.

In certain embodiments, the amphiphilic particles formulated with a non-protein emulsifier are added to liquid foods and/or beverages. Liquid foods include soups, sauces, yogurts, and condiments (e.g., low fat mayonnaise, margarine, ketchup, etc.). Beverages include be any beverage that provides nutrients (e.g., carbohydrates, fats, proteins, amino acids, vitamins, dietary minerals) to an individual (e.g., a human) when consumed, for example, animal/dairy beverages (e.g., cow's milk, goat's milk, sheep's milk, yogurt-containing drinks (nonfat, low-/reduced-fat, including 1%, 1.5%, and 2% fat)), milk made/derived from plants/vegetables (e.g., soymilk, almond milk, coconut milk/water), and other fruit and/or vegetable beverages. In particular embodiments, consumption of the liquid food or beverage to which these amphiphilic particles have been added, as described herein, reduces human plasma cholesterol levels if they are consumed in sufficient quantities over an appropriate length of time (e.g., regular daily intake of 2 g phytosterols, preferably consumed in two or three roughly equal doses during the day).

In certain embodiments, the amphiphilic particles comprising modified (e.g., hydroxylated or hydrolyzed) lecithins enhance the stability of endogenous milk proteins. In some embodiments, the combination of amphiphilic particles and certain dairy products containing supplemental milk proteins, such as skim and low fat milks, prevents heat-induced protein aggregation in the supplemented dairy products.

In certain embodiments, the amphiphilic particles can include an external aqueous phase. That is, the amphiphilic particles may be converted into sterol/fat-in-liquid (oil-in-liquid) emulsion. In some embodiments, the liquid/external aqueous phase can be water, while in other embodiments it can be milk, for example, low-fat cow's milk, or soymilk. These aqueous emulsions may be referred to herein as amphiphilic emulsion pre-mixes. In particular embodiments, the external aqueous phase contains water, thereby forming a sterol/fat-in-water emulsion. In some embodiments, the amphiphilic particles can be added as aqueous emulsions (premixes) to fluid foods and beverages. In other embodiments, depending upon the food or beverage application, the amphiphilic particles can be added to foods and beverages as a free-flowing powder.

Amphiphilic Particles Formulated with Protein-Based Powders

In some embodiments, the amphiphilic particles are formulated (combined or admixed) with at least one water-soluble protein. In particular embodiments, non-fat milk solids or soy proteins are blended with preformed sterol/fat-based complexes to form amphiphilic particles that readily disperse in cow's milk or soymilk, respectively. Amphiphilic particles formulated with protein provide several advantages: first, it renders the amphiphilic particles dispersible in liquid foods such as milk, juices, soups, etc.; second, it converts liquid, semi-liquid, or waxy solid particles into a free-flowing amphiphilic powdered form that is easy to store, transport, manipulate/measure/weigh and disperse; and third, the protein in these amphiphilic particles can enrich certain liquid foods (for example, soymilk and skim cow's milk) with additional high quality protein.

A number of different water-dispersible proteins can be used to form particles depending upon the food or beverage product being supplemented with plant sterols. In certain embodiments, amphiphilic particles for dispersal in soymilk are produced using powdered soy protein isolate or concentrate. In other embodiments, amphiphilic particles for dispersal in cow's milk are produced using lactalbumin powder, milk solids, or whey protein concentrate powder (all from cow's milk), or a combination thereof.

To prepare amphiphilic particles for use in tomato juice, soups and other beverages and fluid foods, amphiphilic sterol/at-based powders can be prepared by blending preformed sterol/fat-based complexes with any of a variety of water-dispersible protein powders such as beef protein, chicken protein, or egg protein powders, and these resultant amphiphilic sterol/fat-based powders can be subsequently dispersed into the food or beverage. For use in fruit juice, amphiphilic particles may be beneficially and conveniently prepared from amphiphilic particles that are formulated with whey protein isolate powder fractionated from milk.

In some embodiments, the protein is a nutrient powder. Nutrient powders may include whey protein powder/concentrates and components of whey such as lactalbumin and lactoglobulin powders, nonfat or low fat dry milk (e.g., rich in casein), soy protein isolate and soy protein concentrate powders. In particular embodiments, the whey protein can contain a low level of fat and cholesterol and lactose, and at least about 29%-89% protein by weight. In some embodiments, the whey protein isolates are processed to remove the fat and lactose, and are at least 90% protein by weight. Certain protein powders are sufficiently amphiphilic that they are able to bind to the sterol/fat-based complexes and have sufficient affinity for water that they facilitate effective and stable dispersal of amphiphilic particles in beverages, even following homogenization and pasteurization of the beverage.

The amount of protein to be combined with preformed sterol/fat-based complexes to obtain powders of amphiphilic particles depends on the concentrations of free sterol and triglyceride oil in the preformed sterol/fat-based complexes. In certain embodiments, the preformed complexes containing a smaller proportion of sterols relative to the proportion of oil requires more protein to produce powders of amphiphilic particles, whereas in other embodiments, preformed sterol/fat-based complexes containing a higher proportion of sterols relative to the proportion of oil requires less protein to produce powders of amphiphilic particles.

In certain embodiments, the amphiphilic particles formulated with protein-based powders are added to liquid foods and/or beverages. In certain embodiments, liquid foods include soups, sauces, yogurts, and condiments (e.g., low fat mayonnaise, margarine, etc.). In some embodiments, the amphiphilic particles are added to beverages such as animal/dairy beverages (e.g., cow's milk, goat's milk, sheep's milk, yogurt-containing drinks (nonfat, low-/reduced-fat, including 1%, 1.5%, and 2% fat)), plant's milk (e.g., soymilk, almond milk, coconut milk/water), and other fruit and/or vegetable beverages. In particular embodiments, the liquid food or beverage to which these amphiphilic particles have been added reduces human plasma cholesterol levels when it is consumed by an individual on a regular basis and over time, as described herein.

In particular embodiments, the amphiphilic particles form a paste rather than a powder. For example, if amphiphilic particles containing about 1 g of sterols complexed with 1 g fat are combined with about 4 g of protein, the result is a paste. In such embodiments, the paste may be pre-mixed with a small portion of liquid to produce an easily dispersible liquid concentrate, which is incorporated into the liquid food.

In certain embodiments, the amphiphilic particles are formulated with a non-protein emulsifier and a protein-based powder. The resulting amphiphilic particles may be either a dry free-flowing powder or a wet paste. These amphiphilic particles (comprising both non-protein emulsifier and protein-based powder) are water-dispersible, and depending on the liquid food or beverage to which the particles are added, the water-dispersible nature may be greater than that of amphiphilic particles formulated with only a non-protein emulsifier or with only a protein-based powder. Many foods and beverages contain a variety of complex surface-active ingredients that themselves can provide a chemical environment that helps stabilize a dispersion of amphiphilic particles. In some foods and beverages that naturally contain a certain level of an emulsifier that aids in dispersing a fat/sterol complex in an aqueous environment, it may be possible to reduce the level of the non-protein or the protein emulsifier incorporated into amphiphilic particles described herein. For example, soy protein has proven to be an adequate and sufficient emulsifier in forming amphiphilic particles that can be dispersed in soymilk, whereas dispersal of amphiphilic particles in cow's milk appears to require the incorporation of a more aggressive emulsifier into the amphiphilic particles such as hydrolyzed lecithin. Empirical testing can be used to determine which emulsifier(s) is/are useful in a particular food or beverage system.

In some embodiments, a free-flowing powder of amphiphilic particles is formed by combining a preformed sterol/fat-based complex and non-protein emulsifier (e.g., TRP+ lecithin) with approximately an equal amount (by weight) of a protein-rich powder (e.g., approximately 1 part by weight sterol and 1 part by weight fat pre-combined in a complex followed by adding 2 parts by weight of whey protein isolate or whey protein concentrate powder, or a non-fat dried milk).

In some embodiments, the amphiphilic particles formulated with a combination of non-protein emulsifiers and protein-based powders are added to liquid foods and/or beverages. In particular embodiments, consumption of the liquid food or beverage to which these amphiphilic particles have been added, as described herein, reduces human plasma cholesterol levels if they are consumed in sufficient quantities over an appropriate length of time (e.g., regular daily intake of 2 g phytosterols, preferably consumed in two or three roughly equal doses during the day).

In certain embodiments, the amphiphilic particles include either an amphiphilic protein or a non-protein emulsifier, or a mixture of sterol/fat-based complexes, protein, and non-protein emulsifier. Any one of the foregoing amphiphilic particles can also contain additional fat. In some embodiments, the amphiphilic particles include sterol/fat-based complexes and at least one protein or at least one emulsifier (e.g., modified lecithin, or mono- and/or diglyceride).

In other embodiments, beverages include animal/dairy beverages (e.g., cow's milk, goat's milk, sheep's milk, yogurt-containing drinks (nonfat, low-/reduced-fat, including 1%, 1.5%, and 2% fat)), plant's milk (e.g., soymilk, almond milk, coconut milk/water), and other fruit and/or vegetable beverages. In certain embodiments, liquid foods include soups, sauces, yogurts, and condiments (e.g., low fat mayonnaise, margarine, etc.).

In particular embodiments, the amphiphilic particles described herein are used to protect polyunsaturated fatty acid moieties in fats by quenching, e.g., scavenging, oxidative free radicals and/or peroxides and hydroperoxides that are formed during exposure of triglycerides to air, and that are particularly problematic in heated fats. Thus, in some embodiments, in addition to their ability to function as a plasma cholesterol-lowering nutraceutical ingredient in dietary supplements and liquid foods, the amphiphilic particles can protect fats against oxidation during storage.

In each of the foregoing embodiments, the amphiphilic particles include non-esterified phytosterols in a hydrophobic crystalline matrix with fats and oils, as described in U.S. Pat. Nos. 7,709,038, 7,575,768, 7,144,595 and 6,638,547.

### EXAMPLES

### Example 1

### Crystalline Phytosterol Composition Formed with Triglycerides

One part by weight tall oil-derived phytosterol or one part by weight soybean-derived prilled phytosterol powder (non-esterified phytosterols) described above were each heated with nine parts soybean oil. The temperature required to solubilize these 10% by weight powders in oil was approximately 75-85° C. It was estimated that approximately 8.5% by weight phytosterols (out of 10% total) recrystallized in the oil following cooling to room temperature. Phase contrast microscopic examination (600× magnification) of the solids showed a mixture of extended needle and plate-type crystalline material suspended throughout the mixture, that differed markedly from the amorphous solids originally placed in the triglyceride oil.

### Example 2

### Formation of Amphiphilic Particles Using Non-Protein Emulsifiers

Amphiphilic particles complex can be produced as follows: approximately 100 parts by weight CoroWise® FG-50 sterols (Cargill) are dissolved in 100 parts by weight Clear Valley® high oleic sunflower oil (Cargill) by heating and mixing these ingredients at 110° C. During subsequent cooling (resulting in sterol/fat crystallization, i.e., a sterol/fat-based complex or TRP), the solution may be votated (mixed) to keep the crystal size small and produce a product having a thick but uniformly smooth consistency. After the product has cooled to room temperature, 10-12 parts by weight of Giralec® HE-60 or Giralec® H-US hydrolyzed sunflower lecithin (Austrade Inc., Palm Beach Gardens, Fla.) are blended into the crystallized sterol/fat-based complex until uniformly distributed. In some embodiments, modified lecithin can be added to the sterol/fat-based complex before it has completely cooled to room temperature (slightly warm). In certain embodiments, the modified lecithin is more effective in aiding dispersal of amphiphilic particles in beverages and liquid foods when it is combined with the sterol/fat-based complex after the complex has cooled completely to room temperature.

### Example 3

### Amphiphilic Particles Dispersed in Water

Five percent (5%) and 10% by weight of hydrolyzed sunflower lecithin (Giralec® HE-60 or Giralec® H-US produced by Austrade, Inc., Palm Beach Gardens, Fla.) was vigorously blended (mechanically mixed) at room temperature with 95% and 90% by weight respectively, of preformed sterol/fat-based complexes. The resulting amphiphilic particles exhibited remarkable water-dispersibility when vigorously agitated (high shear blended) with water. The initial, preformed sterol-fat-based complex contained 50% by weight soybean-derived sterols (FG-50 Corowise® brand) and 50% by weight high oleic sunflower oil (Clear Valley® brand), both ingredients obtained from Cargill, Inc. (Minneapolis, Minn.). The preformed sterol/fat-based complex was produced according to the standard method of heating, cooling and co-crystallizing the mixture as described in U.S. Pat. No. 6,638,547, incorporated herein by reference.

### Example 4

### Amphiphilic Particles Disperse in Water, Soymilk, and Cow's Milk

Applicants have found that both hydrolyzed (e.g., phospholipase A enzyme-hydrolyzed) and hydroxylated modified lecithins proved to be surprisingly effective for dispersing amphiphilic particles into water, soymilk and cow's milk. Sterol/fat-based complexes were produced using one part by weight phytosterols (CardioAidTMnon-esterified sterols from soybeans, produced by Archer Daniel Midland, Inc., Decatur, Ill., also known as “ADM, Inc.”) and two parts by weight soybean oil. These ingredients were heated, dissolved, cooled and allowed to co-crystallize. Five percent (5%) by weight of modified lecithin and 95% by weight of the sterol/fat-based complex were mixed to formulate amphiphilic particles, which was dispersed in water, soymilk, and cow's milk following homogenization. Amphiphilic dispersal was achieved in both warm (37° C.) and cold (4° C.) liquids.

### Example 5

### Amphiphilic Particle Emulsion Pre-Mixes

To provide an emulsion formulation, one part by weight amphiphilic particles containing, for example, 47% soybean phytosterols, 47% high oleic sunflower oil and 6% hydrolyzed sunflower lecithin, can be emulsified with one part by weight warm water. Warming the components (amphiphilic particles and aqueous fluid) facilitates this emulsification process. These amphiphilic particle emulsion pre-mixes can be dispersed easily and directly into beverages and fluid foods.

### Example 6

### Amphiphilic Particles Formulated with Soy Protein Isolate

The amount of protein to be added to preformed sterol/fat-based complexes to obtain powdered amphiphilic particles depends on the concentrations of free sterol and triglycerides in the preformed sterol/fat-based complex. To establish quantities of protein required for formulating an amphiphilic sterol/fat-based powder, three different types of amphiphilic particles were produced using three different preformed sterol/fat-based complexes of free (non-esterified) sterols (Vegapure® FS from Cognis Corp., La Grange, Ill.) and soybean oil (SBO): (1) 25% sterols plus 75% SBO; (2) 50% sterols plus 50% SBO; and (3) 75% sterols plus 25% SBO. Soy protein isolate (SPI) was added stepwise to each sterol-fat-based complex until a free-flowing powder of amphiphilic particles was formed. The results were, as follows: (1) 8 g of SPI and 4 g of sterol/fat complex (25% sterols plus 75% SB) formed an amphiphilic powder; (2) 4 g of SPI and 4 g sterol/fat complex (50% sterols plus 50% SBO) formed an amphiphilic powder; and (3) 2 g of SPI and 4 g sterol/fat complex (75% sterols plus 25% SBO) formed an amphiphilic powder. Thus, the proportion of SPI protein in the newly formulated amphiphilic powder composition decreased nearly linearly as the percentage by weight of sterols in the preformed sterol/fat-based complex (starting material) increased. It is to be understood that these proportions may vary somewhat, depending on the type of fat and protein used to formulate the amphiphilic particles.

### Example 7

### Formulation of an Amphiphilic Soy-Based Concentrate (Paste)

As calculated on the basis of a 12 oz. serving of soymilk, a 2 g quantity of free sterols (Vegapure® FS from Cognis Corp.) was mixed with 2 g of soybean oil and heated to 100-120° C. until the sterols dissolved. As the solution began to cool and crystallize, 4 g of protein powder (either soy protein isolate or soy concentrate) was added and thoroughly mixed until a uniform powder of amphiphilic particles was obtained. These protein powders were also blended with the sterol/fat-based complexes using a wire whisk blender after the complexes had fully cooled to room temperature. A preformed complex containing 50% sterols and 50% oil, for example, is solid at room temperature and can be successfully blended with soy protein powder using vigorous mixing. Depending upon the ingredients and mixing conditions, the functional final product may have either a granular or a powdered appearance.

Applicant has observed that if sterol/fat-based complexes containing only 33% sterols (2 g sterols plus 4 g of soybean oil per serving) are combined with 4 g of protein, the resultant amphiphilic particles produce a heavy paste rather than a powder. While dispersing such a paste into a beverage or fluid food product is somewhat more difficult than dispersing a powder, the paste can be pre-mixed into a small portion of the liquid to produce an easily dispersible liquid concentrate.

### Example 8

### Amphiphilic Particle-Enriched Non-Fat Milk

To produce one 8 oz. serving of protein-enriched, sterol-supplemented “non-fat” milk, 1.00 g free sterols (Cargill CoroWise™ FG-50) was heated and dissolved with 1.00-1.24 g high oleic sunflower oil. After cooling to room temperature, this preformed sterol/fat-based complex was blended using a wire whisk blender with 2.9 g non-fat milk solids to form a powder of amphiphilic particles that was dispersed in skim milk to provide 8 oz of amphiphilic particle-enriched non-fat milk. This product met the requirements of the standard of identity of non-fat milk.

### Example 9

### Amphiphilic Particle-Enriched 1% Low-Fat Milk

To produce one 8 oz serving of milk protein-enriched, sterol-supplemented 1% low-fat milk, 1.00 g free sterols (Cargill CoroWise™ FG-50) was heated and dissolved with 2.00 g anhydrous milk fat. After cooling to room temperature, this preformed complex was blended using a wire whisk blender with 4.6 g non-fat milk solids to form a powder of amphiphilic particles that was dispersed in skim milk to provide 8 oz of amphiphilic particle-enriched 1% low-fat milk. This product met the requirements of the standard of identity of 1% low-fat milk.

### Example 10

### Amphiphilic Particle-Enriched Non-Fat Milk

To obtain amphiphilic particles that are easily dispersed in an 8 oz. serving of non-fat cow's milk, 1 g of non-esterified phytosterols was heated and dissolved with 1 g of a high oleic sunflower oil. Following cooling to room temperature and crystallization of the sterol/fat-based complex, 2 g of the complex was blended with 6% by weight (0.12 g) of hydrolyzed sunflower lecithin (Giralec H-US from Austrade, Inc., Palm Beach Gardens, Fla.). The sterol/fat-based complex was fully cooled and crystallized before combining with lecithin. Lastly, 3.6 g of non-fat milk powder was blended with the amphiphilic particles (formulated with modified lecithin), e.g., using a wire whisk blender, thereby formulating a free-flowing amphiphilic sterol/fat-based powder that was readily homogenized, dispersed, and pasteurized in non-fat liquid milk. Using this recipe, homogenized and pasteurized extended shelf life (ESL) non-fat fluid milk was prepared and packaged in 16 oz. bottles.

### Example 11

### Soymilk Enriched with Amphiphilic Particles Formulated with Protein Lower Human Plasma Cholesterol Levels (Clinical Study #1)

A number of soymilks used in clinical studies were prepared using a soy base concentrate (SunOpta Grains and Foods Group, Hope, Minn.) providing (per 8 oz serving) 5 g fat, 5 g carbohydrates (3 g sugar), 1 g total fiber, 7 g protein and 102 calories, and were supplemented or modified as follows:
1. Soymilk #1 (12 oz) homogenized with 2.0 g microparticulate Vegapure® FS sterols from the Cognis Corp. (>50% of particles smaller than 20 microns); and
2. Soymilk #2 (12 oz. as in #1), but containing 6.9 g of amphiphilic particles dispersed in the beverage (amphiphilic particles consisting of same 2.0 g Vegapure® FS sterols+0.9 g soybean oil heated together and dissolved, cooled and co-crystallized, and then blended with 4.0 g soy protein isolate before homogenizing in soymilk).

For Clinical Study #1, thirty subjects (individuals) were recruited and screened, and twenty qualified for the study (criteria: mildly hypercholesterolemic, not taking any medication and having no known clinical disease). Once enrolled, subjects were acclimated to the study with “control” soymilk (no sterols added), consuming 12 oz/day, divided between meals, for 1 week. Overnight fasting blood glucose levels in freshly drawn blood using an Elite XL glucometer (Bayer Co.) were measured at the beginning and the end of the control week for the twenty subjects. Plasma was analyzed for total cholesterol (TC), triglyceride (TG) and HDL-cholesterol concentration. Based on the above parameters LDL-C and LDL-C/HDL-C were determined (see Table 1, study 1). The very small decreases (2% and 4% respectively) in the levels of TC and LDL-C were not statistically significant.

TABLE 1
Plasma lipids and blood glucose in subjects consuming 12 oz/day soymilk
(no added phytosterols) for 1 week

| | Blood | | | | | |
|---|---|---|---|---|---|---|
| | glucose | TC | TG | HDL-C | LDL-C | LDL-C/HDL-C |
| | mg/dL | mg/dL | mg/d | mg/d | mg/d | ratio |
| Baseline | 90 ± 10 | 203 ± 24 | 102 ± 70 | 57 ± 14 | 125 ± 19 | 2.33 ± 0.67 |
| Soymilk | 88 ± 12 | 199 ± 29 | 100 ± 58 | 59 ± 15 | 120 ± 24 | 2.19 ± 0.77* |
| % change | −1 ± 11 | −2 ± 9 | −3 ± 32 | 4 ± 12 | −4 ± 12 | −7 ± 13 |

Values are mean ± SD (n = 20)
*Significant change (P < 0.05) from baseline by paired T-test

Out of the twenty subjects who consumed the control soymilk, ten were chosen to continue with the study. Of these, five subjects were given soymilk with powdered sterols (soymilk #1 above) and the other five were given soymilk containing amphiphilic particles (soymilk #2 above). As with the control soymilk, subjects were asked to consume 12 oz per day with meals, but for two weeks. Fasting blood glucose levels were measured at the end of weeks 1 and 2, lipoprotein analyses were conducted as described above, and values for the two bleeds were averaged. Due to the small number of subjects in this study, statistical variance was large. Nonetheless, the average TC and LDL-C values for subjects drinking amphiphilic particle-supplemented soymilk decreased significantly (6% and 11% respectively) while both the TC and LDL-C for subjects drinking the unmodified sterol powder-supplemented soymilk decreased only 2%. These findings support the conclusion that amphiphilic particles are more active in gastrointestinal elimination of cholesterol than microparticulate sterols when delivered in soymilk.

### Example 12

### Soymilk Enriched with Amphiphilic Particles Lower Human Plasma Cholesterol Levels (Clinical Study #2)

The following two types of soymilks were prepared:
1. Soymilk #3 (2.5% fat final) contained 8.3 g amphiphilic particles per 12 fl. Oz. (2 servings per day, 6 oz. ea.). Amphiphilic particles: 2.1 g Vegapure® FS sterols, 2.1 g soybean oil and 4.1 g soy protein isolate. Final content of the 12 oz amphiphilic particle-enriched soymilk: 2.0 g sterols, 9.1 g fat (soybean oil), 14.3 g soy protein and 12.2 g carbohydrate including 1.7 g fiber; 131 kcal/8 oz. The sterols and oil were heated together at approximately 110° C. until solubilized, and then cooled. During cooling to room temperature, the mixture was continuously votated to produce a soft creamy solid sterol/fat-based complex that was subsequently blended together with soy protein powder using a wire whisk blender to produce a free-flowing powder of amphiphilic particles. The powder was dispersed in soymilk that was pasteurized and homogenized.
2. Soymilk #4 (3.5% fat final) contained 7.5 g amphiphilic particles per 12 oz (2 servings per day, 6 oz. ea.). Amphiphilic particles: 2.0 g Vegapure® FS sterols, 5.0 g soybean oil and 0.5 g Yelkin® 1018 lecithin from the Archer Daniels Midland Company, Decatur, Ill. Final content of 12 oz amphiphilic particles-enriched soymilk: 2.0 g Vegapure® FS sterols, 12.6 g fat, 0.5 g lecithin, 10.3 g soy protein and 12.2 g carbohydrate including 1.7 g fiber; 131 kcal/8 oz. These ingredients were blended together at ambient temperature to form a slurry. The slurry was dispersed into the soymilk that was pasteurized and homogenized. A microscopic examination of Sudan Black-stained fat present in a sample of the soymilk showed that the sterols had dissolved and co-crystallized with the oil present in the slurry.

Twenty volunteer subjects for Clinical Study #2 were screened and qualified (as per Clinical Study #1) to compare the effects of these two new types of sterol-enriched soymilk on the plasma lipoprotein profile. Due to a limitation in the supply of soymilk, eight subjects in group A (amphiphilic particles formulated with protein), and eleven subjects in group B (amphiphilic particles formulated with modified lecithin) were able to complete the 4 week study. For the nineteen subjects, the average age was 47 years (12 females and 7 males) with an average BMI of 24.

Ten more subjects participated in Study #3 that was conducted according to Study #2, with the exception that all subjects were fed soymilk enriched with amphiphilic particles (formulated with non-protein emulsifier) for 4 weeks, and followed the same protocol and bleed schedule used in Study 2. One of the subjects was disqualified for poor compliance, while the remaining completed the study, as intended.

To establish a baseline lipoprotein profile, 2-3 fasting blood samples were obtained and averaged for each subject before soymilk was consumed. After 4 weeks of consuming soymilk daily, blood glucose and plasma lipids were determined from two more fasting blood samples that were analyzed and averaged. Blood and plasma was analyzed for glucose and TC, TG, HDL-C, LDL-C and LDL-C/HDL-C as described above. The data from Studies 2 and 3 are distributed and summarized in Tables 2 and 3. The results show that while blood glucose and HDL-C levels remained statistically unchanged, TC levels decreased approximately 10% (12% for amphiphilic particles formulated with protein and 8% average for amphiphilic particles formulated with non-protein emulsifier). The LDL-C levels decreased even more, i.e., approximately 14% (16% for amphiphilic particles formulated with protein and 13% average for amphiphilic particles formulated with non-protein emulsifier), while the LDL/HDL ratios decreased an average of 15% for both types of amphiphilic particles (protein or non-protein). Therefore to achieve amphiphilic particle dispersal in soymilk, both powdered soy protein and water-dispersible hydroxylated soy lecithin (Yelkin® 1018) have proven to be very effective agents for formulating amphiphilic particles. The clinical studies included herein, indicate that these agents promote the bioavailability of amphiphilic particles in the gastrointestinal tract for controlling plasma levels of cholesterol in humans.

TABLE 2
Plasma lipids and blood glucose in subjects consuming daily 12 oz soymilk
enriched with 2 g free phytosterols as amphiphilic particles formulated with either protein
or non-protein emulsifiers (4 week study)

| | | | | | |
|---|---|---|---|---|---|
| Blood | | | | | LDL- |
| glucose | TC | TG | HDL-C | LDL-C | C/HDL-C |
| mg/dL | mg/dL | mg/d | mg/d | mg/d | ratio |

amphiphilic particles (protein) (Study 2)

| | | | | | | |
|---|---|---|---|---|---|---|
| Baseline | 90 ± 11 | 220 ± 17 | 121 ± 59 | 56 ± 13 | 140 ± 16 | 2.67 ± 0.80 |
| amphiphilic | 88 ± 16 | 194 ± 17* | 108 ± 48 | 56 ± 14 | 117 ± 18* | 2.26 ± 0.73* |
| particle | | | | | | |
| (protein-based) | | | | | | |
| soymilk | | | | | | |
| % change | −3 ± 15 | −12 ± 7 | −9 ± 17 | −1 ± 5 | −16 ± 11 | −15 ± 14 |

amphiphilic particles (non-protein) (Studies 2 + 3)

| | | | | | | |
|---|---|---|---|---|---|---|
| Baseline | 86 ± 9 | 205 ± 33 | 95 ± 55 | 52 ± 12 | 134 ± 30 | 2.77 ± 1.00 |
| amphiphilic | 84 ± 10 | 187 ± 26* | 86 ± 41 | 54 ± 14 | 117 ± 25* | 2.36 ± 0.90* |
| particle (non- | | | | | | |
| protein-based) | | | | | | |
| soymilk | | | | | | |
| % change | −2 ± 10 | −8 ± 5 | −4 ± 26 | 3 ± 6 | −13 ± 8 | −15 ± 10 |

Values are mean ± SD (soymilk with protein particles, n = 8 and soymilk with non-protein particles, n = 20)
*Significant change (P < 0.05) from baseline, paired T-test

TABLE 3
Plasma lipids and blood glucose in subjects consuming daily 12 oz soymilk
enriched with 2 g free phytosterols as amphiphilic particles formulated with non-protein
emulsifier (4 week study)

| | | | | | |
|---|---|---|---|---|---|
| Blood | | | | | |
| glucose | TC | TG | HDL-C | LDL-C | LDL-C/HDL-C |
| mg/dL | mg/dL | mg/d | mg/d | mg/d | ratio |

Study 2

| | | | | | | |
|---|---|---|---|---|---|---|
| Baseline | 83 ± 8 | 192 ± 26 | 86 ± 58 | 55 ± 13 | 120 ± 19 | 2.29 ± 0.56 |
| amphiphilic particle | 79 ± 9 | 179 ± 24* | 76 ± 43 | 58 ± 15 | 106 ± 17* | 1.98 ± 0.71* |
| (non-protein-based) | | | | | | |
| soymilk | | | | | | |
| % change | −5 ± 8 | −7 ± 4* | −8 ± 15 | 4 ± 7 | −11 ± 8* | −15 ± 12* |

Study 3

| | | | | | | |
|---|---|---|---|---|---|---|
| Baseline | 89 ± 9 | 220 ± 35 | 107 ± 51 | 47 ± 10 | 151 ± 32 | 3.37 ± 1.14 |
| amphiphilic particle | 89 ± 10 | 198 ± 25* | 99 ± 38 | 49 ± 11 | 130 ± 28* | 2.83 ± 1.00* |
| (non-protein-based) | | | | | | |
| soymilk | | | | | | |
| % change | 0 ± 11 | −10 ± 5* | 2 ± 36 | 3 ± 6 | −14 ± 8* | −16 ± 8* |

Values are mean ± SD (soymilk with non-protein emulsifier particles, study 2, n = 11; study 3, n = 9)
*Significant change (P < 0.05) from baseline by paired T-test

### Example 13

### Cow's Milk Enriched with Amphiphilic Particles (Preliminary Clinical Study)

Prior to conducting a human clinical study with 30-40 subjects consuming cow's milk, five volunteer subjects were recruited as described above and consumed two 8 oz servings/d of cow's milk enriched with amphiphilic particles (with meals) for 4 weeks. The cow's milk provided 2 g/d of phytosterols in the form of amphiphilic particles formulated with a combination of protein and non-protein emulsifiers. Results are shown in Table 4. Three of these subjects had participated in one of the preceding soymilk studies that provided the same amount of phytosterols (2 g/day) in the form of amphiphilic particles (formulated with protein) dispersed in two 6 oz servings of soymilk consumed with meals. A comparison of the response of these three individuals consuming the 12 oz soymilk daily and subsequently the 16 oz cow's milk daily is provided in Table 5. In summary, each milk provided 2 g/day phytosterols: amphiphilic particles (formulated with protein) in soymilk, and amphiphilic particles (formulated with both protein and non-protein emulsifiers) in cow's milk. Although the number of human subjects is small, it is reasonable to conclude from the data in Table 4 that the decreases in LDL-C and the ratio of LDL-C/HDL-C are substantially equal for soymilk and cow's milk that provide 2 g/d of phytosterols in the form of amphiphilic particles as described above.

TABLE 4
Plasma lipids and blood glucose in subjects consuming 2 g/d free phytosterols as
amphiphilic particles formulated with protein and non-protein emulsifiers in 16 oz/d fat-
free cow's milk (4 week study)

| | Blood glucose | TC | TG | HDL-C | LDL-C | LDL-C/HDL-C |
|---|---|---|---|---|---|---|
| | mg/dL | mg/dL | mg/d | mg/d | mg/d | ratio |
| Baseline | 82 + 17 | 211 ± 13 | 82 ± 26 | 57 ± 9 | 136 ± 14 | 2.43 ± 0.48 |
| After 3 wk of | 80 ± 22 | 190 ± 16* | 91 ± 35 | 57 ± 11 | 115 ± 22* | 2.10 ± 0.68* |
| milk with | | | | | | |
| amphiphilic | | | | | | |
| particles | | | | | | |
| % change | −3 ± 10 | −10 ± 5** | 10 ± 13 | −1 ± 4 | −16 ± 10** | −16 ± 13** |

Values are mean ± SD (n = 5)
*Significant change (p < 0.05) from baseline by paired T-test
**Percent change significant (p < 0.05)

TABLE 5
Plasma lipid and blood glucose levels in same three subjects consuming 2 g/d phytosterols
as amphiphilic particles formulated with protein in 12 oz/d soymilk and as amphiphilic
particles formulated with non-protein emulsifier in 16 oz/d cow's milk for 4 wks

| | Blood | | | | | |
|---|---|---|---|---|---|---|
| | glucose | TC | TG | HDL-C | LDL-C | LDL-C/HDL-C |
| | mg/dL | mg/dL | mg/d | mg/d | mg/d | ratio |
| Baseline | 87 ± 12 | 211 ± 14 | 81 ± 29 | 64 ± 14 | 132 ± 15 | 2.15 ± 0.62 |
| Soymilk | 83 ± 13* | 185 ± 7* | 69 ± 30 | 66 ± 13* | 106 ± 16* | 1.68 ± 0.59* |
| with | | | | | | |
| protein- | | | | | | |
| based | | | | | | |
| particles | | | | | | |
| % change | −5 ± 3 | −12 ± 3** | −16 ± 15 | 4 ± 2 | −20 ± 6** | −23 ± 5** |
| Baseline | 77 + 14 | 206 ± 12 | 76 ± 28 | 59 ± 12 | 131 ± 16 | 2.29 ± 0.59 |
| Cow's milk | 70 ± 15* | 180 ± 12* | 80 ± 35 | 60 ± 14 | 105 ± 23* | 1.83 ± 0.73* |
| with non- | | | | | | |
| protein- | | | | | | |
| based | | | | | | |
| particles | | | | | | |
| % change | −10 ± 4** | −12 ± 3** | 4 ± 13 | 1 ± 4 | −20 ± 8** | −22 ± 10** |

Values are mean ± SD (n = 3)
*Significant change (P < 0.05) from baseline by paired T-test
**Percent change significant (p < 0.05)

Those skilled in the art will recognize or be able to ascertain using no more than routine experimentation many equivalents to the specific embodiments described herein. The scope of the present invention is not intended to be limited to the above Description, but rather is as set forth in the appended claims.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the description and claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim. For example, any claim that is dependent on another claim can be modified to include one or more limitations found in any other claim that is dependent on the same base claim.

Where elements are presented as lists, e.g., in Markush group format, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not been specifically set forth in haec verba herein. It is also noted that the term “comprising” is intended to be open and permits the inclusion of additional elements or steps.

Where ranges are given, endpoints are included. Furthermore, it is to be understood that unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the methods of the invention can be excluded from any one or more claims, for any reason, whether or not related to the existence of prior art.

Each of the foregoing patents, patent applications and references is hereby incorporated by reference.

1. A composition, comprising:
(a) at least one non-esterified phytosterol co-crystallized with at least one triglyceride-based edible fat; and
(b) at least one amphiphilic agent in an amount effective to form an amphiphilic particle that disperses in liquid, wherein the at least one amphiphilic agent is present at a level of about 2% to about 70% by weight of the composition.

2. The composition of claim 1, wherein component (a) comprises:
(i) at least one non-esterified phytosterol in an amount of about 2% to about 75% by weight of component (a); and
(ii) at least one triglyceride-based edible oil or fat in an amount of about 25% to about 98% by weight of component (a).

3. The composition of claim 1, wherein the at least one amphiphilic agent comprises at least one emulsifier.

4. The composition of claim 3, wherein the at least one emulsifier is a non-protein-based emulsifier.

5. The composition of claim 4, wherein the non-protein-based emulsifier is a modified lecithin.

6. The composition of claim 5, wherein the modified lecithin is hydrolyzed or hydroxylated.

7. The composition of claim 4, wherein the at least one non-protein-based emulsifier is a monoglyceride, a diglyceride, or a combination thereof.

8. The composition of claim 3, wherein the at least one emulsifier is a water-soluble protein.

9. The composition of claim 8, wherein the water-soluble protein is a milk protein or soy protein.

10. The composition of claim 9, wherein the milk protein is casein, beta-lactoglobulin, or alpha-lactalbumin.

11. The composition of claim 3, wherein the at least one emulsifier comprises a mixture of proteins.

12. The composition of claim 8, wherein the water-soluble protein is in powdered form.

13. The composition of claim 1, wherein the at least one amphiphilic agent comprises at least one non-protein-based emulsifier and at least one water-soluble protein.

14. The composition of claim 1, wherein the amphiphilic particles form a paste.

15. The composition of claim 1, wherein the amphiphilic particles form a powder.

16. The composition of claim 1, comprising a beverage, a liquid food, a liquid dietary supplement, or a liquid food additive.

17. The composition of claim 16, wherein the beverage is a nutritional beverage.

18. The composition of claim 17, wherein the nutritional beverage is cow's milk, sheep's milk, goat's milk, soymilk, almond milk, or coconut milk.

19. The composition of claim 16, wherein the liquid food is yogurt, cottage cheese, sour cream, soup, salad dressing, tomato catsup, mustard, barbecue sauce, steak sauce, Worcestershire sauce, cocktail sauce, tartar sauce, pickle relish, tomato-based pasta sauce, pizza sauce, prepared chili, or dessert sauce.

20. The composition of claim 1, wherein the at least one triglyceride-based edible fat is vegetable oil, vegetable fat, animal oil, animal fat, or a mixture thereof.

21. The composition of claim 1 wherein the at least one non-esterified phytosterol is a plant or vegetable oil-derived phytosterol or phytostanol, a tall oil-derived phytosterol or phytostanol, or a combination thereof.

22. A method for reducing plasma cholesterol levels in an individual, comprising administering to the individual the composition of claim 1 in an amount sufficient for reducing plasma cholesterol levels in the individual.

23. A method of producing an amphiphilic particle, comprising:
(a) obtaining a complex comprising at least one non-esterified phytosterol co-crystallized with at least one triglyceride-based edible fat; and
(b) combining with the complex of (a) at least one amphiphilic agent in an amount effective and under conditions appropriate to form an amphiphilic particle that disperses in liquid, thereby producing an amphiphilic particle.

24. A method of producing an amphiphilic particle, comprising:
(a) combining from about 2% to about 75% by weight of non-esterified phytosterols with from about 25% to about 98% by weight of at least one triglyceride-based edible fat;
(b) heating the non-esterified phytosterols and fat in (a) under conditions sufficient for the non-esterified phytosterols to dissolve in the edible fat;
(c) cooling the non-esterified phytosterols dissolved in fat under conditions sufficient for the non-esterified phytosterols and fat to co-crystallize and form a sterol- and fat-based complex; and
(d) combining with the sterol- and fat-based complex at least one amphiphilic agent in an amount effective to form an amphiphilic particle that disperses in liquid, thereby producing an amphiphilic particle.

25. A beverage or liquid food comprising the composition of claim 1.

26. The composition of claim 4, wherein the at least one emulsifier is a non-protein-based emulsifier present in the composition at from about 2% to about 20% by weight of the composition.

27. The composition of claim 8, wherein the at least one emulsifier is a water-soluble protein present in the composition at from about 10% to about 70% by weight of the composition.
